(19) United States
(12) Patent Application Publication
(10) Pub. No.: US 2010/0106648 A1
(43) Pub. Date: Apr. 29, 2010

(54) Method and apparatus for acquiring encryption key to provide pay channel

(75) Inventors: Young-Jin Choi, Suwon-si (KR); Jeong-Sik Cho, Suwon-si (KR); Young-Jip Kim, Suwon-si (KR); Joon-Ho Park, Suwon-si (KR); Byoung-Dai Lee, Seongnam-si (KR); Tae-Soo Lee, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/589,650

(22) Filed: Oct. 27, 2009

(30) Foreign Application Priority Data
Oct. 29, 2008 (KR) 10-2008-0106635

(51) Int. Cl. H04L 9/32; H04K 1/00; G06Q 20/00

(52) U.S. Cl. 705/67; 380/270; 713/163

(57) ABSTRACT

A mobile terminal is configured to acquire an encryption key to decrypt a pay channel encrypted with a smartcard profile by the mobile terminal in a Multimedia Broadcast/Multicast Service (MBMS) mobile broadcast system. The mobile terminal is configured to purchase a specific pay channel, determine validity of an encryption key, store a range of a valid encryption key identification value, and initialize a reference Time Stamp (TS) value. The mobile terminal also; extracts an encryption key identification value and a TS value from a last received Short Term Key Message (STKM), when a view request for the specific pay channel is created; and determines that an encryption key is valid, when the extracted TS value satisfies the reference TS and the extracted encryption key identification value falls within a range of the valid encryption key identification value, and extracts and acquires an encryption key from the STKM.

### CROSS-REFERENCE TO RELATED APPLICATION(S) AND CLAIM OF PRIORITY

The present application is related to and claims the benefit under 35 U.S.C. §119(a) of a Korean Patent Application filed in the Korean Intellectual Property Office on Oct. 29, 2008 and assigned Serial No. 10-2008-0106635, the entire disclosure of which is hereby incorporated by reference.

### TECHNICAL FIELD OF THE INVENTION

The present invention relates to a pay channel service in a Multimedia Broadcast/Multicast Service (MBMS) mobile broadcast system. More particularly, the present invention relates to a method and apparatus for acquiring an encryption key to provide a received pay channel to a user in a mobile terminal.

### BACKGROUND OF THE INVENTION

The mobile communication market continuously requires creation of new services through recombination or integration of the existing technologies. Current development of communication and broadcast technologies has allowed the conventional broadcasting systems and mobile communication systems to provide broadcast services through portable terminals (or mobile terminals), such as mobile phones and Personal Digital Assistants (PDAs). A mobile broadcast service that provides broadcast services to mobile terminals is also under commercialization and standardization.

For example, commercial services based on Digital Video Broadcast-Handheld Convergence of Broadcast and Mobile Services (DVB-H CBMS) are now available in Italy, while Vietnam has started to provide commercial services based on Open Air Interface (OAI) led by Nokia. In addition, there are various mobile broadcast service-related standards such as Satellite/Terrestrial Digital multimedia Broadcasting (S/T-DMB), DVB-Satellite services to Handheld (DVB-SH), Open Mobile Alliance Mobile Broadcast (OMA-BCAST), and Multimedia Broadcast/Multicast Service (MBMS).

Mobile broadcast service offers a broadband television broadcasting service to a plurality of specified or unspecified mobile terminals. The mobile broadcast service, in which a mobility concept is added to the existing broadcast service, provides useful value-added services that users can conveniently use, including web broadcasting, games and software distribution, as well as television broadcasting. Some of diverse service contents offer pay services that provide the service contents only to the users who purchased them by paying.

Unlike other mobile broadcast services such as S/T-DMB and DVB-SH that separately require broadcasting frequencies in addition to the communication frequencies, MBMS is a technology capable of providing broadcasting using a Wideband Code Division Multiple Access (WCDMA) communication network. This technology services both of communication and broadcasting by upgrading the WCDMA communication network without additional investment such as installation of base stations.

A Service and Content Protection (SCP) technology is also defined in MBMS to protect mobile broadcast contents regarding pay services. MBMS SCP is a technology for encrypting broadcast contents using a specific key so that only the users authorized for a specific broadcast content may access the content.

MBMS SCP can be divided into two different types of profiles

a Digital Right Management (DRM) profile and a smartcard profile

according to an encryption key management method. The DRM profile uses the OMA-DRM standard, while the smartcard profile uses a key management standard contained in a smartcard installed in a mobile terminal.

A broadcast server, which employs the smartcard profile, encrypts a broadcast stream for a pay channel with an encryption key, i.e., an MEMS Traffic Key (MTK), before broadcasting the broadcast stream in order that only the users who purchased the pay channel may view the channel. The broadcast server broadcasts the encrypted broadcast stream together with a Short Term Key Message (STKM) including an encryption key needed for decrypting the encrypted stream.

Structures of the STKM are illustrated in FIGS. 1A and 1B. Referring to FIG. 1A, an STKM includes a Common Header (HDR) field 100, an Extension (EXT) field 110 in which an MTK value is stored, a Time Stamp (TS) field 120 in which a TS value is stored, and a KEMAC field 130. Referring to FIG. 1B, the EXT field 110 includes a Key Domain ID field 101, and Key Type ID fields 102 and 103 including an MBMS Service Key (MSK) ID and an MTK ID, respectively.

An MTK ID value, which is an identification value of an MTK, is used to allow only the mobile terminal that purchased a pay channel through a proper procedure among mobile terminals that received the above STKM, to extract the MTK from the received STKM.

Upon purchase of a pay channel, the mobile terminal acquires a range of a valid MTK ID value, or a valid MTK ID range, from a pay channel provider, and stores the acquired data. The valid MTK ID range stored in the mobile terminal is determined as “SEQ₁<MTK_ID≦SEQᵤ”, where SEQ₁ and SEQᵤ denote the minimum value and the maximum value of the valid MTK ID range, respectively.

When a user of the mobile terminal selects a pay channel later on, the mobile terminal extracts an MTK ID value from the received STKM in real-time. The mobile terminal compares the valid MTK ID range stored therein with the extracted MTK ID value, and extracts an MTK from the STKM only when the extracted MTK ID value falls within the valid MTK ID range. If the extracted MTK ID value does not fall within the valid MTK ID range, or no valid MTK ID range is stored, the mobile terminal cannot acquire an MTK even though it has received the STKM.

Meanwhile, an MTK is changed at stated periods in order to increase its security. Such an example is illustrated in FIG. 2. Referring to FIG. 2, while an encrypted stream 200 corresponding to a pay channel is transmitted, an MTK transmitted through a key stream 210 is changed to MTK_ID (1), MTK_ID (2), MTK_ID (3) and MTK_ID (4) at every predetermined crypto period.

Though an STKM includes the MTK that periodically changes as stated above, the STKM is broadcasted at a period shorter than a change period of the MTK. If a mobile terminal normally acquires an encryption key for a pay channel from the STKM as its user selects the pay channel, the mobile terminal changes the minimum value SEQ1 of a valid MTK ID range stored therein to an MTK ID value extracted from the STKM.

Therefore, if the mobile terminal selects a pay channel twice within the same crypto period, the mobile terminal may not acquire the MTK before expiration of the same crypto period.

### SUMMARY OF THE INVENTION

To address the above-discussed deficiencies of the prior art, it is a primary object to provide to provide at least the advantages described below. Accordingly, an aspect of the present invention provides a method and apparatus for allowing a user to view a purchased specific pay channel anytime before expiry of its lifetime when the user purchased the pay channel through a normal purchase procedure.

Another aspect of the present invention provides a method and apparatus capably of normally acquiring an encryption key.

According to one aspect of the present invention, there is provided a method for acquiring an encryption key to decrypt a pay channel encrypted with a smartcard profile by a mobile terminal in a Multimedia Broadcast/Multicast Service (MBMS) mobile broadcast system. The method includes purchasing a specific pay channel, receiving a minimum encryption key identification value SEQ₁ and a maximum encryption key identification value SEQᵤ used to determine validity of an encryption key, storing a range of a valid encryption key identification value, defined by an equation of SEQ₁≦encryption key identification value≦SEQᵤ, and initializing a reference Time Stamp (TS) value; extracting an encryption key identification value and a TS value from a last received Short Term Key Message (STKM), when a view request for the specific pay channel is created; and determining that an encryption key included in the STKM is valid, when the extracted TS value satisfies the reference TS and the extracted encryption key identification value falls within a range of the valid encryption key identification value, and extracting and acquiring an encryption key from the STKM.

According to another aspect of the present invention, there is provided a mobile terminal apparatus for acquiring an encryption key to decrypt a pay channel encrypted with a smartcard profile by a mobile terminal in a Multimedia Broadcast/Multicast Service (MBMS) mobile broadcast system. The mobile terminal apparatus includes a terminal configured to purchase a specific pay channel, deliver, to a smartcard, a minimum encryption key identification value SEQ₁ and a maximum encryption key identification value SEQᵤ used to determine validity of an encryption key, extract an encryption identification value and a Time Stamp (TS) value from a last received Short Term Key Message (STKM) when a view request for the pay channel is created, deliver the extracted values to the smartcard, and extract and acquire an encryption key from the STKM when a validity notification is provided from the smartcard; and the smartcard configured to store a range of a valid encryption key identification value, defined by an equation of SEQ₁≦encryption key identification value≦SEQᵤ, use the minimum encryption key identification value SEQ₁ and the maximum encryption key identification value SEQᵤ, initialize a reference TS value, determine that an encryption key included in the STKM is valid, when the extracted TS value satisfies the reference TS and the extracted encryption key identification value falls within the range of the valid encryption key identification value, and deliver a notification indicating the validity to the terminal.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A and 1B illustrate a general structure of a Short Term Key Message (STKM);

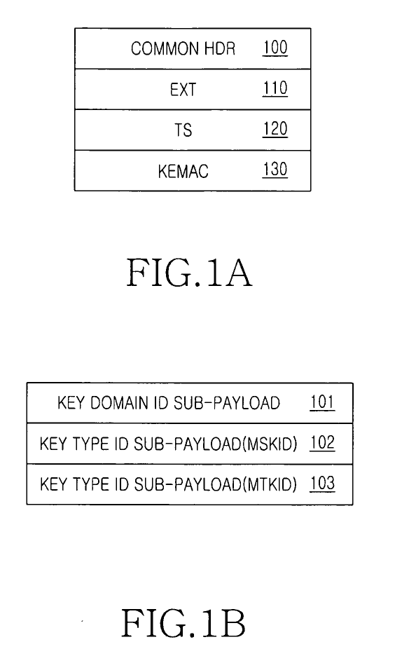

FIG. 2 illustrates a periodic change of an MBMS Traffic Key (MTK);

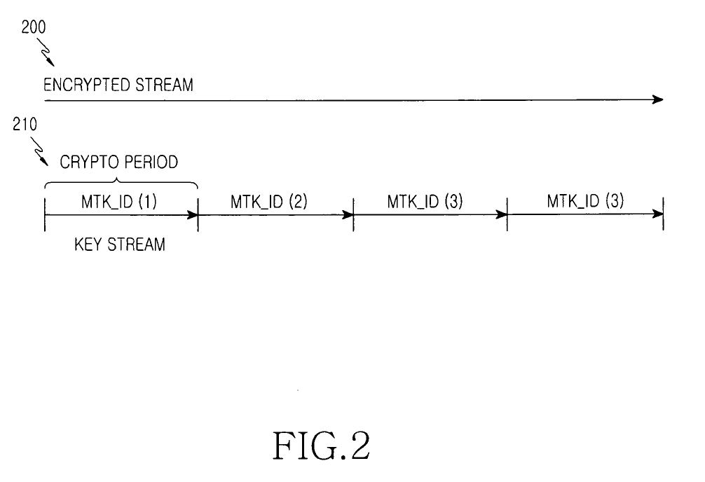

FIG. 3 illustrates a conventional process of determining validity of an MTK;

FIG. 4 illustrates a configuration of a mobile broadcast system to which the present invention is applied;

FIG. 5 illustrates an operation of a mobile terminal according to an exemplary embodiment of the present invention; and

FIG. 6 illustrates a process of determining validity of an MTK according to an exemplary embodiment of the present invention.

Throughout the drawings, the same drawing reference numerals will be understood to refer to the same elements, features and structures.

### DETAILED DESCRIPTION OF THE INVENTION

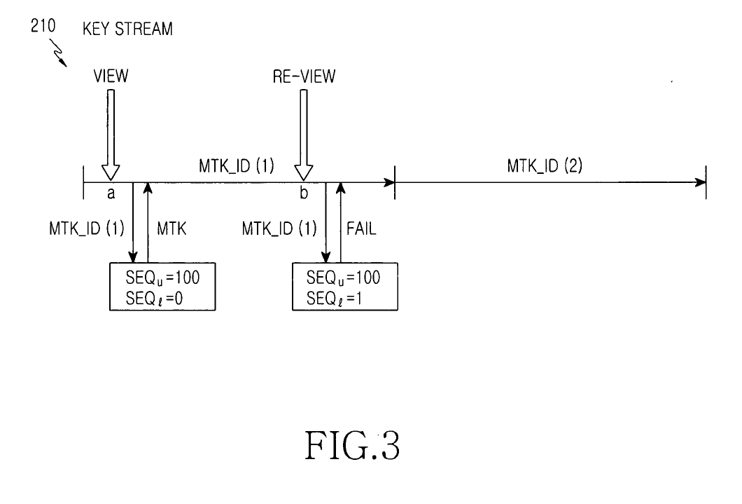

FIGS. 3 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

An STKM includes the MTK that periodically changes, the STKM is broadcasted at a period shorter than a change period of the MTK. If a mobile terminal normally acquires an encryption key for a pay channel from the STKM as its user selects the pay channel, the mobile terminal changes the minimum value SEQ1 of a valid MTK ID range stored therein to an MTK ID value extracted from the STKM.

Therefore, if the mobile terminal selects a pay channel twice within the same crypto period, the mobile terminal may not acquire the MTK before expiration of the same crypto period.

An example of this case is illustrated in FIG. 3. In this example, it is assumed that initial values of a valid TS range stored in the mobile terminal that purchased a pay channel are SEQ₁=0 and SEQᵤ=100. Referring to FIG. 3, when a mobile terminal selects a pay channel at a time “a” in a first crypto period for which an MTK_ID (1) is maintained as a valid MTK, the mobile terminal extracts the MTK_ID (1) from the last received STKM as an MTK_ID. The MTK_ID (1) means that an MTK_ID value is “1.” The extracted MTK_ID value satisfies a valid MTK_ID range of “SEQ₁=0<MTK ID=1≦SEQᵤ=100.” Accordingly, the mobile terminal can extract an MTK from the STKM. Then the mobile terminal adjusts the valid MTK_ID range by changing SEQ₁ to “1.”

Thereafter, if a user of the mobile terminal reselects the pay channel at a time “b,” for example, if the user reselects the pay channel after zapping to another channel or the user intends to re-view the pay channel after ending viewing the pay channel, an MTK_ID value included in the STKM is also an MTK_ID (1) since the MTK_ID (1) is still valid. However, because the valid MTK_ID range is “SEQ₁=1<MTK_ID≦SEQᵤ=100,” the extracted MTK_ID value does not fall within the valid MTK_ID range. Hence, the mobile terminal cannot extract an MTK from the STKM.

In this case, even though a user has normally purchased a pay channel, the STKM received with the same MTK_ID is determined invalid for the first crypto period, so that the user may not view the channel in this period.

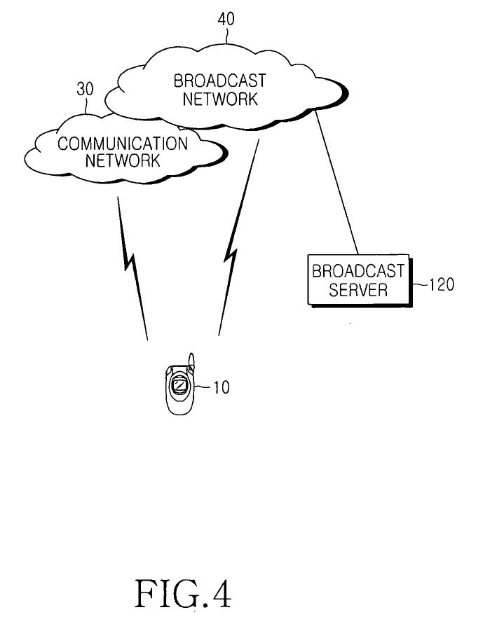

A mobile broadcast system to which the present invention is applied will now be described with reference to FIG. 4. Referring to FIG. 4, the mobile broadcast system includes a communication network 30, a broadcast network 40, a mobile terminal(s) 10, and a broadcast server 20.

The communication network 30 provides broadcast services based on a wire communication service, a mobile communication service and a mobile broadcast service, while the broadcast network 40 provides broadcast services based on a mobile broadcast service.

The broadcast server 20 provides a variety of broadcast contents and broadcast guide information to the mobile terminals 10 over the communication network 30 and the broadcast network 40 according to a standard for the mobile broadcast service. The broadcast server 20 encrypts a specific channel with an encryption key and provides it as a pay channel.

If the mobile terminal 10 requests purchase of the pay channel over the communication network 30, and normally performs a procedure for purchasing a pay channel, such as accounting, then the broadcast server 20 delivers a range of a valid identification value for identifying an encryption key, to the mobile terminal 10. As a result, the mobile terminal 10 can use only the encryption key that includes the valid identification value.

In an exemplary embodiment of the present invention, an encryption key represents an MBMS Traffic Key (MTK) and an identification value for the MTK is indicated by MTK_ID. Therefore, the mobile terminal 10 is provided with the minimum MTK_ID value and the maximum MTK_ID value as a valid MTK_ID value from the broadcast server 20.

The mobile terminal 10, which can be a portable terminal such as a mobile phone and a Personal Digital Assistant (PDA), carries out a mobile broadcast service provided from the communication network 30 and the broadcast network 40, provides the mobile broadcast service to the user, and performs a communication service such as mobile communication. The mobile terminal 10 can purchase a pay channel according to an exemplary embodiment of the present invention, and stores an identification value range of a valid encryption key, i.e., a valid MTK_ID range, using the minimum MTK_ID value and the maximum MTK_ID value provided from the broadcast server 20 during the purchase of a pay channel. A reference TS can be used together with the valid MTK_ID range as a criterion for determining a valid MTK, according to the present invention.

The mobile terminal 10, which is a terminal supporting a smartcard profile, includes a smartcard, in which the valid MTK_ID range and reference TS received from the broadcast server 20 are stored. In accordance with the present invention, the stored valid MTK_ID range is given in Equation 1:

SEQ₁≦MTK_≦ID SEQᵤ

where SEQ₁ denotes the minimum MTK_ID value, SEQᵤ the maximum MTK_ID value, and MTK_ID an MTK_ID value extracted from an STKM.

The reference TS indicated by TS_{—old} has a range defined by Equation 2:

TS_{—old}<TS

where TS denotes a value extracted from the STKM.

The reference TS is initialized to the least value, e.g. ‘0’, during the purchase of a pay channel.

Upon receipt of a view request for a pay channel, the mobile terminal 10 extracts an MTK_ID and a TS value from the last received STKM, determines if the extracted MTK_ID satisfies (falls within) the valid MTK_ID range and the extracted TS value satisfies the reference TS, and determines that the STKM is valid, if they satisfy the valid MTK_ID range and the reference TS. The mobile terminal 10 extracts an MTK from the STKM depending on the determination result, decrypts the pay channel with the extracted MTK, decodes the decrypted pay channel, and provides the decoded channel to the user. The mobile terminal 10 changes the SEQ₁ value to the MTK_ID value extracted from the STKM, and also changes the TS_{—old} value to the extracted TS value.

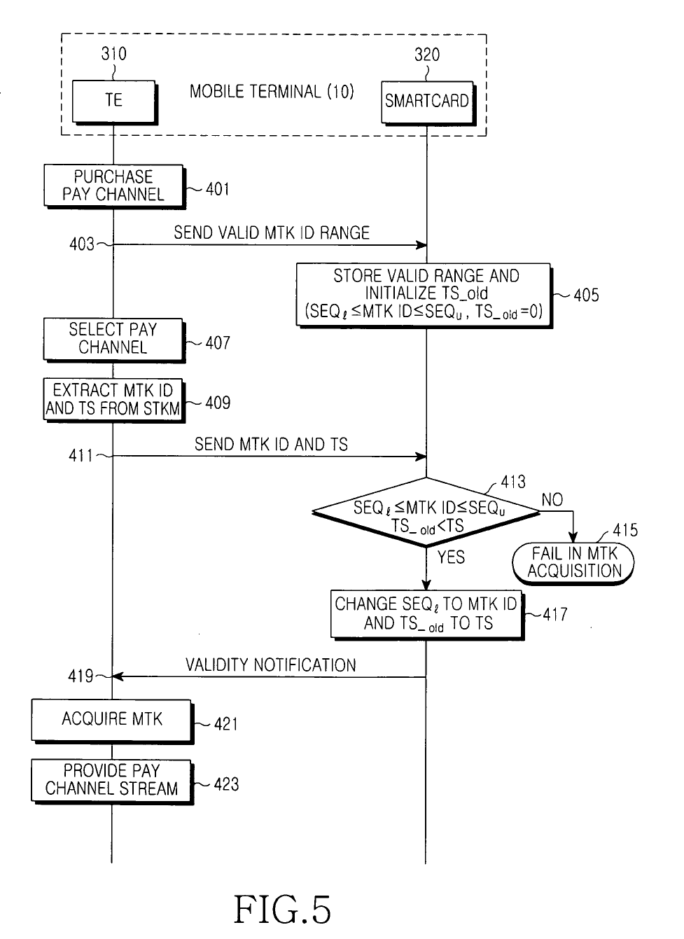

FIG. 5 illustrates an operation of a mobile terminal 10 according to an exemplary embodiment of the present invention. Referring to FIG. 5, the mobile terminal 10 includes a smartcard 320 and a Terminal (TE) 310, and the TE 310 equipped with the smartcard 320 is referred to as the mobile terminal 10. Although not illustrated, the TE 310 includes a controller configured to control the overall operation of the TE 310 and accessing the smartcard 320, a memory unit used as a working memory of the controller, for store program data and received data associated with a function of the TE 310, a display configured to display broadcast data and various other data, a key input unit, a Radio Frequency (RF) communication unit configured to perform RF communication, and a broadcast receiver configured to receive and handle a broadcast stream.

Upon purchase of a pay channel, the mobile terminal 10 is provided with information SEQ₁ and SEQᵤ necessary for pay channel decryption from a broadcast server 20 in step 401. The TE 310 delivers the SEQ₁ and SEQᵤ to the smartcard 320 in step 403, and the smartcard 320 stores a valid MTK_ID range of Equation 1 using the provided SEQ₁ and SEQᵤ, and initializes the reference TS value TS_{—old} in step 405.

Thereafter, upon receipt of a view request for a pay channel from a user, the TE 310 selects the pay channel in step 407, and extracts an MTK_ID and a TS value from the last received STKM in step 409. The TE 310 delivers the extracted MTK_ID value and TS value to the smartcard 320 in step 411.

The smartcard 320 determines, in step 413, if the provided MTK_ID value and TS value fall within a valid MTK_ID range and a reference TS range, respectively, and determines that the MTK included in the last received STKM is valid, if they fall within the valid MTK_ID range and the reference TS range. Then, in step 417, the smartcard 320 changes the SEQ₁ to the MTK_ID value extracted in step 409, and also changes the TS_{—old} to the TS value extracted in step 409. The smartcard 320 notifies the TE 310 that the MTK is valid, in step 419.

If the provided MTK_ID value or TS value does not fall within the valid MTK_ID range or does not satisfy the reference TS, the smartcard 320 determines that the MTK included in the STKM is invalid, and fails in MTK acquisition in step 415.

Upon receiving a notification from the smartcard 320, indicating that the MTK is valid, in step 421 the TE 310 acquires the MTK from the STKM used in step 409 and may provide a pay channel stream to the user in step 423.

According to the present invention, as the mobile terminal acquires the MTK as described above, the mobile terminal can seamlessly provide broadcast on the pay channel to the user even when it selects the pay channel twice or more times for the same crypto period.

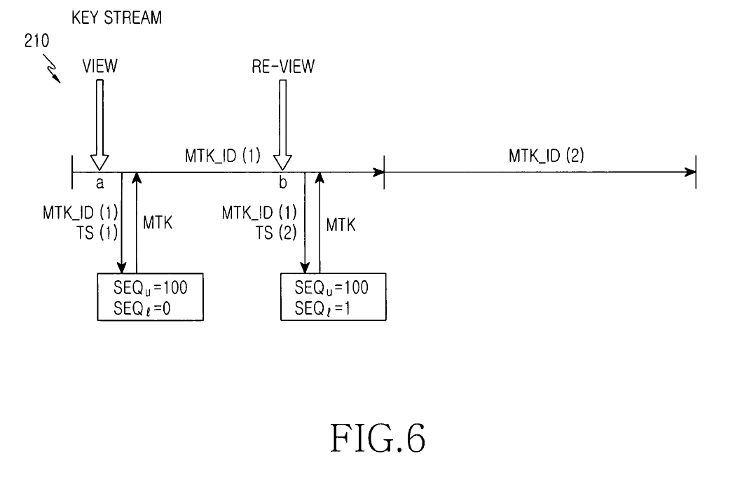

Such an example is illustrated in FIG. 6. In this example, it is assumed that initial values of a valid MTK_ID range stored in the mobile terminal that purchased a pay channel are SEQ₁=0 and SEQᵤ=100. Referring to FIG. 6, when a mobile terminal selects a pay channel at a time “a” in a first crypto period for which an MTK_ID (1) is maintained as a valid MTK, the mobile terminal extracts the MTK_ID (1) from the last received first STKM as an MTK_ID value. Further, the mobile terminal extracts a TS (1) from the first STKM as a TS value. The MTK_ID (1) and TS (1) mean that their values are “1.”

The extracted MTK_ID value satisfies a valid MTK_ID range of “SEQ₁=0≦MTK_ID=1≦SEQᵤ=100,” and the extracted TS value satisfies a reference TS range of “TS_{—old}=0<TS=1.” Accordingly, the mobile terminal can extract an MTK from the first STKM. Then the mobile terminal 10 adjusts the valid MTK_ID range by changing SEQ₁ to “1,” and adjusts the reference TS by changing TS_{—old} to “1.”

Thereafter, if a user of the mobile terminal reselects the pay channel at a time “b,” for example, if the user reselects the pay channel after zapping to another channel or the user intends to re-view the pay channel after ending viewing the pay channel, even though a second STKM, or a new STKM, is received at the time “b,” an MTK_ID value included in the second STKM is an MTK_ID (1), because the MTK_ID (1) is still valid. However, a TS value included in the second STKM is TS (2).

However, because the valid MTK_ID range and the reference TS stored in the mobile terminal 10 at the time “b” are “SEQ₁=1≦MTK_ID≦SEQᵤ=100” and “TS_{—old}=1<TS”, respectively, the extracted MTK_ID (1) value falls within the valid MTK_ID range and the extracted TS (2) also satisfies the reference TS. Hence, the mobile terminal can extract an MTK from the STKM.

As is apparent from the foregoing description, according to exemplary embodiments of the present invention, if a user purchased a specific pay channel through a proper purchase procedure, the user may normally acquire an encryption key and view the purchased pay channel with the acquired encryption key anytime before a lifetime of the purchased pay channel expires.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for acquiring an encryption key to decrypt a pay channel encrypted with a smartcard profile by a mobile terminal in a Multimedia Broadcast/Multicast Service (MBMS) mobile broadcast system, comprising:
purchasing a specific pay channel;
obtaining an encryption key identification value and a Time Stamp (TS) value from a last received Short Term Key Message (STKM); and
determining that an encryption key included in a STKM is valid, when the obtained TS value satisfies a reference TS and the obtained encryption key identification value falls within a range of a valid encryption key identification value, and extracting and acquiring an encryption key from the STKM.

2. The method of claim 1, wherein obtaining comprises:
extracting the encryption key identification value and the TS value from the last received Short Term Key Message (STKM), when a view request for the specific pay channel is created.

3. The method of claim 2, wherein obtaining further comprises:
receiving a minimum encryption key identification value SEQ₁ and a maximum encryption key identification value SEQᵤ used to determine validity of an encryption key;
storing a range of a valid encryption key identification value defined by an equation of SEQ₁≦encryption key identification value SEQᵤ; and
initializing a reference Time Stamp (TS) value.

4. The method of claim 1, wherein the reference TS is defined by the following equation,
TS_{—old}<TS
where TS_{—old} denotes a reference TS value, and TS denotes the extracted TS value.

5. The method of claim 4, further comprising changing the minimum encryption key identification value SEQ₁ to the extracted encryption key identification value within the range of the valid encryption key identification value, when the extracted encryption key identification value falls within the range of the valid encryption key identification value.

6. The method of claim 5, further comprising decrypting a broadcast stream corresponding to the pay channel with use of the acquired encryption key, decoding the decrypted broadcast stream, and providing the decoded broadcast stream to a user.

7. The method of claim 5, wherein the acquired encryption key is an MBMS Traffic Key (MTK).

8. A mobile terminal apparatus configured to acquire an encryption key to decrypt a pay channel encrypted with a smartcard profile by a mobile terminal in a Multimedia Broadcast/Multicast Service (MBMS) mobile broadcast system, the apparatus comprising:
a terminal configured to:
obtain an encryption identification value and a Time Stamp (TS) value from a last received Short Term Key Message (STKM) when a view request for the pay channel is created; and
a smartcard configured to:
store a range of a valid encryption key identification value, defined by an equation of SEQ₁≦encryption key identification value≦SEQᵤ;
use the minimum encryption key identification value SEQ₁ and the maximum encryption key identification value SEQᵤ;
initialize a reference TS value;
determine that an encryption key included in the STKM is valid, when the obtained TS value satisfies the reference TS and the obtained encryption key identification value falls within the range of the valid encryption key identification value; and
deliver a notification indicating the validity to the terminal.

9. The apparatus of claim 8, wherein when the terminal obtains the encryption identification value and the Time Stamp (TS) value, the terminal further is configured to:
purchase a specific pay channel;
deliver, to a smartcard, the minimum encryption key identification value SEQ₁ and the maximum encryption key identification value SEQᵤ used to determine validity of an encryption key;
extract the encryption identification value and the Time Stamp (TS) value from the last received Short Term Key Message (STKM) when a view request for the pay channel is created; and
deliver the extracted values to the smartcard.

10. The apparatus of claim 9, wherein when the terminal obtains the encryption identification value and the Time Stamp (TS) value, the terminal further is configured to extract and acquire an encryption key from the STKM when a validity notification is provided from the smartcard.

11. The mobile terminal apparatus of claim 8, wherein the reference TS is defined by the following equation,
TS_{—old}<TS
where TS_{—old} denotes a reference TS value, and TS denotes the extracted TS value.

12. The mobile terminal apparatus of claim 11, wherein the smartcard changes the minimum encryption key identification value SEQ₁ to the extracted encryption key identification value within the range of the valid encryption key identification value, when the extracted encryption key identification value falls within the range of the valid encryption key identification value.

13. The mobile terminal apparatus of claim 12, wherein the terminal decrypts a broadcast stream corresponding to the pay channel with use of the acquired encryption key, decodes the decrypted broadcast stream, and provides the decoded broadcast stream to a user.

14. The mobile terminal apparatus of claim 13, wherein the acquired encryption key is an MBMS Traffic Key (MTK).

15. A terminal for use in a device configured to decrypt a pay channel encrypted with a smartcard profile by a mobile terminal in a Multimedia Broadcast/Multicast Service (MBMS) mobile broadcast system, the terminal comprising:
a controller configured to obtain an encryption identification value and a Time Stamp (TS) value from a last received Short Term Key Message (STKM) when a view request for the pay channel is created, the controller further configured to:
store, in a smart card, a range of a valid encryption key identification value, defined by an equation of SEQ₁≦encryption key identification value≦SEQᵤ;
use the minimum encryption key identification value SEQ₁ and the maximum encryption key identification value SEQᵤ;
initialize a reference TS value; and
determine that an encryption key included in the STKM is valid, when the extracted TS value satisfies the reference TS and the extracted encryption key identification value falls within the range of the valid encryption key identification value.

16. The terminal of claim 15, wherein when the terminal obtains the encryption identification value and the Time Stamp (TS) value, the terminal further is configured to:
purchase a specific pay channel;
deliver, to a smartcard, the minimum encryption key identification value SEQ₁ and the maximum encryption key identification value SEQᵤ used to determine validity of an encryption key;
extract the encryption identification value and the Time Stamp (TS) value from the last received Short Term Key Message (STKM) when a view request for the pay channel is created;
deliver the extracted values to the smartcard; and
extract and acquire an encryption key from the STKM when a validity notification is provided from the smartcard.

17. The terminal of claim 15, wherein the reference TS is defined by the following equation,
TS_{—old}<TS
where TS_{—old} denotes a reference TS value, and TS denotes the extracted TS value.

18. The terminal of claim 17, wherein the controller changes the minimum encryption key identification value SEQ₁ to the extracted encryption key identification value within the range of the valid encryption key identification value, when the extracted encryption key identification value falls within the range of the valid encryption key identification value.

19. The terminal of claim 18, wherein the terminal decrypts a broadcast stream corresponding to the pay channel with use of the acquired encryption key, decodes the decrypted broadcast stream, and provides the decoded broadcast stream to a user.

20. The terminal of claim 19, wherein the acquired encryption key is an MBMS Traffic Key (MTK).
